(19) United States
(12) Patent Application Publication
(10) Pub. No.: US 2002/0189150 A1
(43) Pub. Date: Dec. 19, 2002

(54) Castable, deep-swimming fishing lure

(76) Inventor: David L. Thorne, Kaysville, UT (US)

Correspondence Address: DAVID L. THORNE, 1759 South 450 East, Kaysville, UT, 84307, US

(21) Appl. No.: 10/224,952

(22) Filed: Aug. 21, 2002

Related U.S. Application Data
(63) Continuation-in-part of application No. 09/750,460, filed on Dec. 28, 2000.

(51) Int. Cl. A01K 85/00

(52) U.S. Cl. 43/42.15

(57) ABSTRACT

A bimodal, two-part, weighted lure which exhibits a remarkable simulation of life-form swimming action while being towed through water. Weights inherently disposed within the lure permits casting, jigging and trolling without additional weight being added to a fishing line external to the lure. The lure begins the swimming action immediately upon being displaced from a resting state. A loop whereat fishing line is affixed to steer and tow the lure rotates to be hidden while being towed. Form and action of the lure permits use with spinner bait and buzz bait wire forms. Also, a replaceable tail apparatus permits exchanging tails to add variety to a lures appearance and to replace damaged tails.

### CONTINUATION-IN-PART

This is a Continuation-in-part of currently pending U.S. patent application Ser. No. 09/750,460 filed Dec. 28, 2000 by David L. Thorne who is also the inventor of record of the inventive elements in this Continuation-in-part.

### FIELD OF INVENTION

The present invention relates generally to jigging lures and to lures which are inherently weighted to permit casting without adding additional weight to a line to which the lure is affixed. Further, the present invention relates to lures which exhibit a realistic simulation of a swimming fish.

### DESCRIPTION OF RELATED ART

It has long been a desire to make a hard bait fishing lure which simulates the swimming motion of a fish as it is moved through water. A number of hard bait fishing lures are currently available commercially which exhibit some simulation of swimming. Examples of such lures are known by trade names of “Flat Fish” and “Rapala”. There are numerous other lures which are patterned like Flat Fish and Rapala lures.

Flat Fish lures are made in an arcuate shape and exhibit a high frequency oscillation when drawn through water. The oscillation is highly unstable and often results in twisting and ultimate tangling of line unless a swivel is used. Generally, the Flat Fish lures are not sufficiently heavy to be castable without some kind of weight added to a line to which the lure is affixed. Further, weight must also be externally added on an attached line to sink the Flat Fish lure to a desired, predetermined trolling depth or for casting.

Rapala lures are currently the most popular of commercial “lipped” lures. Plates affixed to the leading edge of Rapala lures are called lips and are primarily responsible for the lure's simulated swimming action. Various displacement of lips relative to the front end of the lure determines whether the lure is a shallow or deep diving lure. Even so, unless a deep diving Rapala lure is heavily externally weighted, it is normally slow to sink and does not exhibit sinking characteristics associated with a jigging lure. Of course, jigging lures are also well known, most often being simplistic weights disposed about a hook shank. Jigs are not known for realistic swimming motion.

Rapala and other lures may also be found as two part or two segment lures. Such lures are generally made in two parts to provide freedom for a back part to wag relative to a part being pulled. However, there are no known lures wherein a wagging of a back part substantially affects direction of motion of a front part.

Weighted lures are known in the fishing lure art. An example of a weighted fishing lure is disclosed in U.S. Pat. No. 4,317,305 issued May 2, 1982 to Herman P. Firmin (Firmin). Firmin discloses a frontally disposed weight member ahead of a resilient body. The body has a pair of recesses posteriorly disposed relative to the weight member and a thinned section of the body. Primary swimming simulation of the lure of Firmin is an oscillatory tail.

Examples of fishing lures which wobble are disclosed in U.S. Pat. Nos. 5,189,825 issued Mar. 2, 1993 to John E. Stewart (Stewart) and 5,381,623 issued Jan. 17, 1995 to James J. Crisp (Crisp). Stewart discloses a lure having a body which is flexibly connected to a framework which can remain stable while the body exhibits action; weight is frontally disposed relative to a head of the body. Crisp discloses a crank lure which connects a fishing line to the top of a lure head and disposes a hook superiorly and a tail inferiorly to cause the lure to remain upright and wobble.

Numerous weighted lures for jigging and the like are disclosed in U.S. Pat. Nos. 3,729,850, 5,119,581, 5,197,221 and 5,216,830. However, all of these lures have single weights and are designed to simply wobble or oscillate. In no case does an oscillatory motion of a weighted tail substantially displace a head of any particular lure out of line with a towing fishing line.

In a similar fashion, U.S. Pat. No. 5,522,170 issued to Allan S. Cole Jun. 4, 1996 (Cole) has no weight, but is designed to oscillate in the fashion of an injured fish made possible by attachment of a flexible, elongated tail. Notably, the lure of Cole has a front end of a rear section which is hingeably associated with a rear end of a front section.

In one embodiment, a lure as taught by Cole is similar in appearance to a lure made according to the present invention, but the connecting geometries of the rear end of the front section and weighting of the rear sections are significantly different. This embodiment of Cole has a V-shaped wedge in the rear end of the front section and a complementary V-shaped cavity in the front end of the rear section to permit the front and rear sections to nest or dovetail together to form a hidden joint. Notably, the leading edge of the front end of this embodiment is taught to have a beveled or slightly concave surface which is given responsibility for lure oscillation or wobble as the lure is pulled through water. It may also be noted that action of such lures according to Cole are the combined result of front face design, articulating front and rear sections and a flexible, elongated tail which act synergistically to produce an irregular swimming action which simulates a wounded fish when moved through water.

Weights may be used to stabilize a lure. Such is the case in U.S. Pat. No. 5,678,350 issued to Moore which teaches a weight disposed in a head section of a lure for the purpose of stabilizing the head.

In particular, there are no known hard body lures which combine a rear section of a front end of a lure which is contoured to direct water into a forward facing “V” shaped rear part which acts in combination with weight disposed in the rear part to cause the tail to wag and communicate the wagging motion to an attached fore part as does a lure made according to this invention.

### BRIEF SUMMARY AND OBJECTS OF THE INVENTION

In brief summary, this novel invention alleviates all of the known problems related to providing a castable lure which sinks in a manner similar to a jigging lure and which has an extraordinary swimming motion. The swimming motion is sufficiently random and diverse that, from time to time, the fore part (head) of the lure is directed away from the direction of tow of a fishing line. The lure is internally weighted to assure a desired rate of sinking. Weighting of the lure can be varied to provide a variety of sinking rates without unduly affecting the swimming motion. Lures made according to the instant invention are generally vertically stable when displaced in water and thereby resist line twisting. Such lures are immediately impelled to a swimming motion when moved through water, permitting the lure to be swimmingly “jigged” from a lake or stream bottom. In such cases, lures, when jigged upward from the bottom, respond with an immediate realistic, non-repeating, somewhat random swimming motion. In addition, the lure can be towed or trolled over a wide range of velocities while continuing to exhibit a randomized and surprisingly realistic simulated swimming motion.

Generally, the lure is a “hard bait” variety and is distinguishable as two parts, a fore part, generally associated with the head of the lure, and a rear part, generally associated with the tail of the lure, and may be configured as a “lipless” lure. Each part is individually weighted and has a predetermined center of gravity site. Movement of the lure is compound or “bimodal”, based upon a first basic mode of action (wobble) of the fore part and a second basic mode of action (wag) of the rear part.

A rear or aft portion of the fore part is hingeably affixed to a fore portion of the rear part to permit the rear part to oscillate with the wagging motion somewhat independent of the fore part. A connecting loop affixed to the fore part permits fishing line to be affixed to the lure in a predetermined region above a center of gravity of the fore part, yet below the top of the head and well below a dorsal area of the lure. The dorsal area (which may be a fin), in cooperation with the loop which resides above the weight in the head, assures vertical stability of the fore part. Importantly, the fore part is elongated and thinned rearward to form a surface along which water is steered by surface phenomenon toward the connection with the rear part.

The rear part has a pair of vertically disposed, inwardly angled, forward facing fascia which are juxtaposed relative to one another. In a preferred embodiment, the fascia form the “V” shaped wedge having a sufficiently open angle to permit the rear part to wag from side to side relative to the thinned rearward portion of the fore part as a result of water which is steered into the “V” by contour of the thinned rearward end of the fore part.

It should be noted that, due to weighting of the rear part, wagging of the rear part causes the fore part to wag also, displacing the lure from side to side in an irregular, but life-like swimming motion. The rear part is forced, by fluid flow across the trimmed portion of the fore part into the wedge and upon rear portions of the rear part, to wag, first toward one side and then back to the other. The weight in the rear part has a center of gravity which is distally disposed away from the hinge and is of sufficient mass to determine a rearwardly disposed center of rotation of the wagging rear part. The center of rotation is displaced sufficiently from the hinge connection with fore part to rotate he hinge connection out of alignment from the direction the lure is being towed. This hinge displacement is communicated to the rear portion of the fore part to also drive the fore part out of alignment (in the opposite direction).

Thus, sideways displacement of the rear part at the hinge tends to turn the fore part, frequently causing sideways displacement of the entire lure and abetting the simulated swimming motion. A small notch, disposed at the top of the “V” wedge, acts as a spoiler for fluid flowing between the head and rear parts and further smooths action of the rear part when displaced through a current. Further, wobble of the fore part increases sideways instability of the rear part to further promote the wagging motion.

In a preferred embodiment, the hinge functions as a two-part orthogonal eyelet hinge. For example, when using an eyelet hinge, that portion of the hinge which is affixed to the fore part is vertically oriented. That portion of the hinge which is affixed to the rear part is horizontally oriented, permitting the fore part to wobble and the rear part to wag from side to side.

In summary, a lure made according to the present invention comprises two parts, a fore part and a rear part. The fore part is essentially symmetrical about a first vertical plane and has a bulbous forward portion wherein a loop for attaching a fishing line is securely affixed above and forward from a center of gravity of the fore part. Rearward from the center of gravity, a portion of the fore part is contoured and thinned to steer water flowing across the bulbous portion first toward and then substantially parallel to the vertical plane. A weight is disposed beneath the loop and between the loop and thinned portion to fix the site of the center of gravity and center of rotation of the fore part in free space.

The rear part is essentially symmetrical about a second vertical plane and has a pair of vertically disposed, forward facing fascia, each of which forms a forwardly disposed acute angle with the second vertical plane. At a predetermined site rearward from the fascia, a weight is disposed to fix the center of gravity and of rotation of the rear part in free space.

The fore and rear parts are interconnected by a hinge which conjuncts the two vertical planes and facilitates wagging of the rear part. Fluid (water) flow steered by the thinned portion acts upon the fascia to cause the rear part to wag. Wagging motion and angular momentum about the center of rotation of the rear part thrusts the hinge outward from the direction of tow of the fishing line, rotating the fore part and causing the bulbous portion and loop to depart from the direction of tow.

Accordingly, it is a primary object to provide a hard body fishing lure having a realistic swimming motion as it is displaced in water.

It is an important object to provide a castable lure which does not require additional weight added to a connecting fish line.

It is another important object to provide a lure which rapidly sinks in a manner expected of a jig.

It is an object to provide a lure which may be jigged.

It is an object to provide a jigging lure which jigs from a water bottom with a swimming motion.

It is an object to provide a lipless lure which, when displaced through water, exhibits a realistic swimming motion.

It is an object to provide a lure which is stable while being trolled and therefore does not twist line as a result of lure action.

It is an object to provide a lure which sinks without additional weight being added to a line affixed to the lure, thereby achieving a natural looking lure sans weights disposed on the line.

It is an object to provide a swimming lure which retains a substantially horizontal disposition while being towed or trolled through water.

It is an object to provide a compound or two part hard body lure having one part which wobbles and one part which wags, the two parts interacting to provide rapid activation of a swimming motion and continued activation of a swimming motion through a wide range of lure speeds in water.

It is an object to provide a lure according to the invention which is operable as a part of a spinner bait lure system.

It is an object to provide a lure according to the invention which is operable as a part of a buzz bait lure system.

It is an important object to provide a hard bait lure system by which a tail part may be replaceably added to a rear portion of the lure.

These and other objects and features of the present invention will be apparent from the detailed description taken with reference to accompanying drawings.

### BRIEF DESCRIPTION OF THE DRAWINGS

FIG. 1 is a lateral elevation of a lure affixed to a fishing line.

FIG. 2 is a lateral elevation of the lure seen in FIG. 1 with a loop articulated to facilitate fishing line attachment.

FIG. 3 is a top elevation of the lure seen in FIGS. 1.

FIG. 4 is a medial section of a lateral elevation of the lure seen in FIG. 2 with proximal parts removed so inner parts of the lure may be seen.

FIG. 5 is an exploded perspective of parts of the lure seen in FIGS. 1-4.

FIG. 6 is a side elevation of a lure made in accordance with the instant invention configured for jigging.

FIG. 7 is a magnified perspective of a wire frame forming a double loop with an opening for attaching to another loop.

FIG. 8 is a magnified perspective of a wire frame forming a double loop, each of the loops being closed.

FIG. 9 is a magnified perspective of an omega clip which provides an opening for attaching to another loop.

FIG. 10 is a side elevation of another embodiment of a lure made according to the invention and affixed to a spinner bait wire form.

FIG. 11 is a side elevation of yet another embodiment of a lure made according to the invention and affixed to a buzz bait wire form.

FIG. 12 is a top view perspective example of a lure being displaced through water.

FIG. 13 is a perspective of still another lure embodiment with a fixed eyelet whereat fishing line is affixed to the lure.

FIG. 14 is a medial section of a lateral elevation of the lure seen in FIG. 13 with proximal parts removed so inner parts of the lure may be seen.

FIG. 15 is a lateral elevation of another embodiment, of a lure made according to the instant invention, which has a dual hook, a removable tail and a guard which is disposed in the vicinity of a site where the hook is affixed to the lure to protect against hook fouling.

FIG. 16 is a top view of the lure seen in FIG. 15.

FIG. 17 is an exploded perspective of a lure which is similar to the lure seen in FIGS. 15 and 16.

### DETAILED DESCRIPTION OF THE ILLUSTRATED EMBODIMENTS

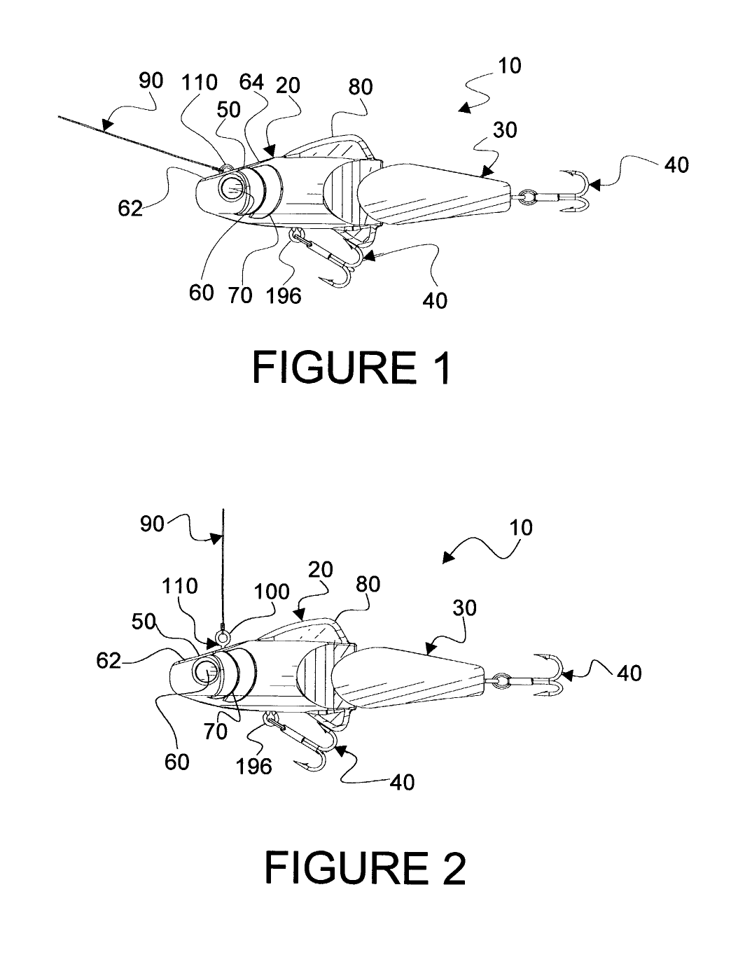

In this description, the term proximal is used to indicate the segment of the device normally closest to the object of the sentence describing its position. The term distal refers to the other end. Reference is now made to the embodiments illustrated in FIGS. 1-17 wherein like numerals are used to designate like parts throughout. As seen in FIG. 1, a fishing lure 10 comprises a fore part 20 and a rear part 30. Treble fish hooks, generally numbered 40, may be affixed to either fore part 20 or rear part 30 or to both parts. It is preferable to have at least one hook affixed to rear part 30. Ganged treble, single and other hook combinations which are lawful and legal may be affixed to lure 10 within the scope of the instant invention.

For realistic appearance, fore part 20 may have a frontal section 50 shaped to resemble a head of a fish, although other shapes may be used within the scope of the invention. As part of frontal section 50, a circular indentation 60 provides space whereat an eye may be affixed.

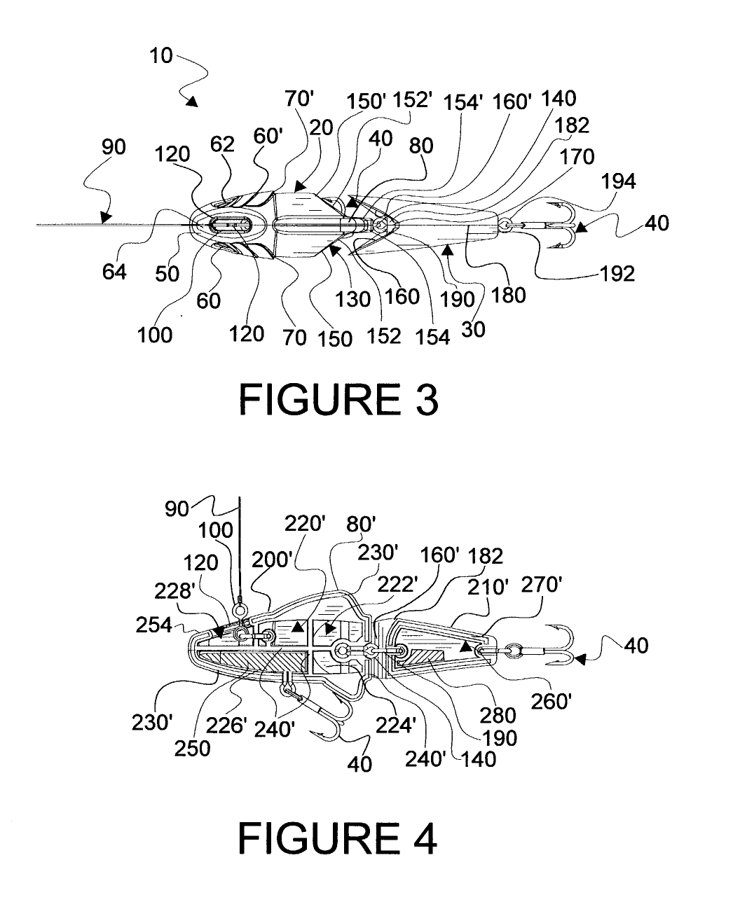

On the superior or top side 62 of frontal section 50, fore part 20 comprises a sloped, planar area 64 (More clearly seen in FIG. 3). It has been found that sloping area 64 at approximately 20° relative to the long axis of lure 10 greatly improves performance.

Other features which add realism to lure 10 may also be added, of which a gill line 70 is an example. Further, fore part 20 has a dorsal fin 80 disposed rearward from frontal section 50. Of course, similar features and markings are usually symmetrically disposed on both sides of lure 10. Generally, parts, features and markings which are represented by given numbers on one side of lure 10 and are replicated as mirror images on the other side of lure 10 are represented by primes of the given numbers on the one side.

Note in FIG. 1, that a fishing line, represented by a line segment 90 appears to extend out of frontal section 50 with only a partially visible connecting loop. For optimal simulation of swimming, it has been experimentally determined that line segment 90 should be so disposed relative to frontal section 50 and dorsal fin 80 to provide optimal wobble of fore part 20. While other sites of line connection may be used within the scope of the instant invention, such a connection is recommended.

To accomplish such a fishing line connection, a line connecting loop 100 of an articulating hinge member 110 is provided as is seen in part in FIG. 2. By articulating member 110 upward as seen in FIG. 2, a fishing line, such as line segment 90, may be facilely affixed by a fisherman's knot. Once lure 10 is disposed in water where fish motion relative to the water causes resistance to pull forces exerted via line segment 90, hinge member 110 is downwardly displaced to at least partially hide articulating member 110 as seen in FIG. 1. While such a hinge member is preferred for optimum performance, a more standard fixed loop (shown in an embodiment disclosed hereafter) may be used within the scope of the invention.

As seen in FIG. 3, frontal section 50 comprises a slot 120 into which connecting loop 100 articulates by resistive forces which occur when lure 10 is displaced through water. Distally aftward from frontal section 50, fore part 20 has a thinned section 130 proximal to a connecting hinge loop 140 by which rear part 30 is hingeably affixed to fore part 20. As best seen in FIG. 3, thinned section 130 has a pair of inwardly disposed surfaces 150 and 150′ which provide boundary layer surfaces for water being displaced along fore part 20. Note that surface 150 has an inwardly directed component 152 and a less inwardly directed component 154 which in combination steer water toward rear part 30. Similarly, surface 150′ comprises like components 152′ and 154′.

Rear part 30 comprises a pair of forwardly disposed angled faces 160 and 160′. Faces 160 and 160′ cooperate to form a wedge 170 centered at a midline 180 of rear part 30. Though not absolutely necessary to the invention, disposed at the top of wedge 170 is a notch 182 which acts as a spoiler for fluid flow thereat and thereby stabilizes and improves swimming action. Rear part 30 is hingeably joined to hinge loop 140 (see also FIG. 4) via another loop 190. At aft end 192, rear part 30 comprises a hook loop 194 whereby a hook 40 is affixed thereto. Though not required within the scope of the invention, rear part 30 is also thinned posteriorly.

Note also, in FIGS. 1 and 2, that a hook 40 is affixed to fore part 20 by a hook loop 196. As is understood by fishermen and those skilled in fishing lure art, only one hook is required on a lure, though multiple hooks may make a lure more efficient. Also different hook combinations may be affixed to lure 10, such, for example, as ganged treble hoods and single hooks, so long as such may be affixed to a lure within legal limits.

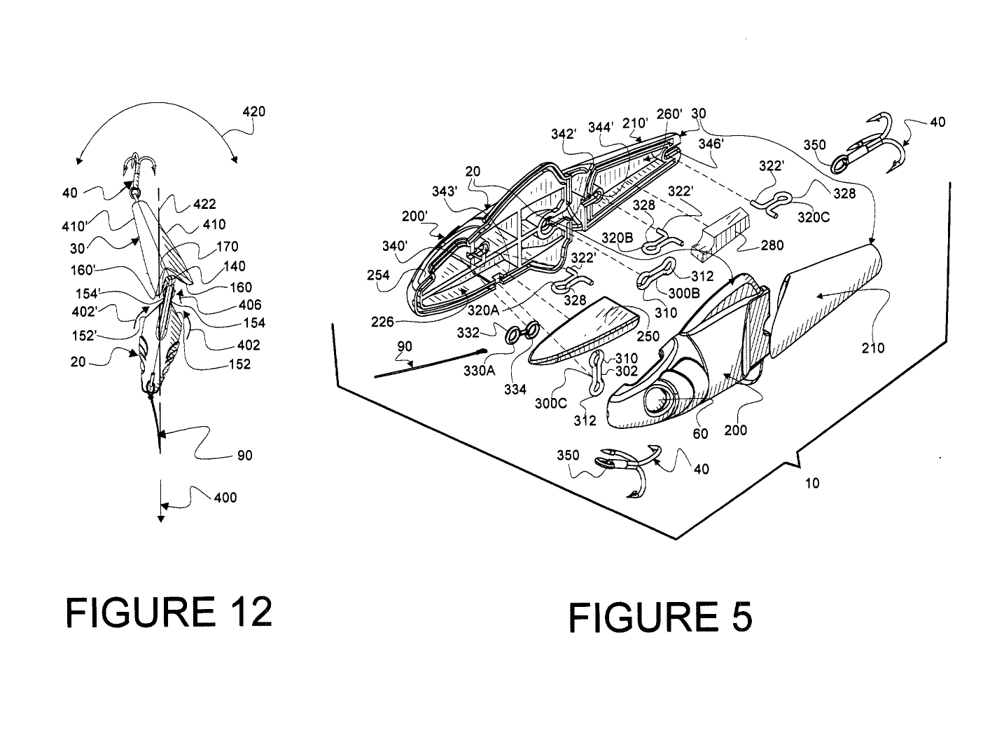

Although lure 10 may be manufactured in many ways within the scope of the invention, one mode of lure 10 construction is seen in FIGS. 4 and 5. As seen in FIG. 5, fore part 20 may be molded as two separate parts, numbered 200 and 200′. Similarly rear part 30 may be molded as two separate parts, numbered 210 and 210′.

Reference is now made to FIG. 4 wherein facing halves, parts 200 and 210, of lure 10 have been removed for clarity of presentation. It should be noted that all features disclosed for parts 200′ and 210′ are repeated in mirror image format in parts 200 and 210, except for complimentary features as disclosed hereafter.

Part 200′ comprises a portion 80′ of dorsal fin 80 which is integrally molded as a part of part 200′. Inferiorly disposed relative to dorsal fin portion 80′, part 200′ comprises a plurality of cavities 220′, 222′, 224′, 226′ and 228′. Further, part 200′ comprises raised edging, generally number 230′, which acts as a tongue in a tongue and groove relationship with part 200 to permit parts 200′ and 200 to be joined and sealed to form a single part (i.e. fore part 20). An internal structure, generally numbered 240′, separates cavities 220′, 222′, 224′, 226′ and 228′ from each other. As it may be desired, though not required, to sequester gas (air) within some of the cavities (e.g. cavities 220′ and 222′) to improve lure 10 stability, structure 240′ may be raised in part or in total to perform as a tongue in a tongue and groove relation with complementary portions of part 200 (not shown) to independently seal selected cavities.

Note a section of a weight 250 disposed in cavity 226′. It is important that weight 250 (or at least the center of gravity of weight 250) be inferiorly disposed relative to a site where force from line 90 is imposed upon lure 10. So disposed, weight 250 in combination with a superiorly displaced connection of line 90 and superior fore part features of which dorsal fin 80 is an example, causes fore part 20 to wobble as it is displaced relative to a surrounding fluid (water) environment. The mass and density of weight 250 may be varied to adjust for predetermined fishing depth of lure 10, rate of sinking when lure 10 is jigged, ease of casting of lure 10 and other variables which characterize lure 10 for a desired fishing method. However, it is important to note that weight 250 and a weight disposed in rear part 30 (described hereafter) must be positioned properly and have predetermined weight ratios, one to the other, for optimum operation of lure 10. As an example, for a lure having a fore part 20, shaped as seen in FIGS. 1-3, having a maximum girth of 1.2 centimeters and a length of 3.75 centimeters, weight 250 may be approximately nine grams and be distally disposed relative to loop 100.

Superiorly, cavity 228 is open at slot 120 (see also FIG. 3) into which connecting loop 100 articulates to be hidden as lure 10 is displaced through water. A subtle feature of fore part 20 is a sloped planar face 254 disposed about slot 120. Planarity of face 254 markedly improves wobble action of fore part 20.

Part 210′, as seen in FIG. 4, comprises an open cavity 260′ which is generally outlined by a raised edging 270′. Like edging 230′, edging 270′ acts as a tongue in a tongue and groove relationship with part 210 to permit parts 210′ and 210 to joined and sealed to form a rear part (i.e. rear part 30). Edging 270′ outlines cavity 260′, which, when parts 210′ and 210 are joined, houses a weight 280, seen segmented in FIG. 4. Weight 280 may be disposed such that the center of gravity is along the line of force of pull of line 90. The center of gravity may be even higher if weight 250 is sufficiently heavy and so disposed to provide stability in light of disposition of weight 280. However, it is generally advisable to have the center of gravity of weight 280 disposed below the line of force of pull of line 90. For a rear part 30 having a length of 3.75 centimeters, weight 280 may be approximately 1.8 grams, the center of gravity of which should reside about one centimeter behind hinge 140.

Assembly of lure 10 may be determined by review of FIGS. 5 and 7-9. A plurality of loop connections are made to connect fore part 20, rear part 30 and hooks 40 to provide an operable lure which is affixable to a line 90. It should be duly noted that the loop connections are for the most part exemplary and other types of connections, especially hinge connections, may be used to assemble lure 10 within the scope of the invention.

One mode of connection may be made using a double loop snap ring 300, as seen in FIG. 7. Snap ring 300 comprises a wire frame 302 which defines an accessible opening 304 formed at wire ends 306 and 308. Opening 304 is directly associated with a proximal loop 310 and a distal loop 312. Note that a separate loop may be displaced through opening 304 into loop 310 and therefrom by separating closing portions of frame 302 further into loop 312. Ring 300 is generally made of metal having sufficient spring to permit separation of closing portions of frame 302 and to reclose the separating portions of frame 302 to retain a loop in frame 302, unless removed by force, thereafter. Snap rings, like ring 300, are generally commercially available.

Another mode of connection is an omega clip 320 seen in FIG. 9. Omega clip derives its name from being shaped like the Greek letter omega. Clip 320 comprises a wire frame 321 having pair of outwardly disposed arms, 322 and 322′ which may be used as anchors to affix clip 320 to a structure. As seen in FIG. 9, each arm 322 and 322′ comprises a bend 324 and 324′, respectively, to respectively extend into two parallel compressively joined segments 326 and 326′. Distal from bends 324 and 324′, segments 326 and 326′ separate to join in a common arcuate loop 328. Similar to snap ring 300, omega clip is generally made from a spring metal and is commercially available as a separate part.

A closed double loop connector 330 is seen in FIG. 8. Connector 330 is generally dumb bell shaped having a pair of loops 332 and 334 and an intervening stem 336. Connector 330 may be made from metal or synthetic resinous material and various useful sizes and types of connector 330 are commercially available.

It may be noted in FIG. 5 that connecting components used in lure 10 are made up of a plurality of snap rings 300, omega clips 320 and connectors 330. For clarity, in FIG. 5 each individual ring, clip or connector is referenced by a number and a following character to specifically mark and identify each connecting component. As an example, a connector associated with hinge member 110 (see FIG. 2) is numbered 330A. Please note that dashed lines provide an indication of direction of displacement for assembly of parts to construct lure 10.

To affix connecting components to parts 200, 200′, 210 and 210′, each such part has a structure which comprises slots or holes in which the connecting components are securely anchored. As an example, part 200′ has a blind hole 340′ in which an arm 322′ of omega clip 320A is inserted. Rearward from hole 340′, part 200′ has a slot 342′ which is formed to anchor loop 310 of snap ring 300B.

Inferiorly disposed relative to hole 340′, part 210′ has a slot 343′ through which frame 302 of snap ring 300C is displaced such that loop 310 resides inside cavity 226′.

Part 210′ has a blind hole and associated slot 344′ for anchoring arm 322′ of omega clip 320B. Rearward from hole 344′, part 210′ has another blind hole and associated slot 346′ for arm 322′ of omega clip 320C.

Though not shown, parts 200 and 210 have holes or slots which are complementary to those mentioned above for engaging and anchoring the referenced connecting components. Also for clarity, each hook 40 comprises a connecting loop 350.

To assemble the part 200′ portion of lure 10, loop 334 of connector 330A is displaced into loop 328 of omega clip 320A. Arm 322′ of omega clip 320A is displaced into blind hole 340′. In this manner, loop 332 of connector 330A performs as loop 100. (See FIGS. 2-4). Loop 328 of omega clip 320B is displaced into loop 312 of snap ring 300B. So assembled loop 310 of snap ring 300B is displaced into slot 342′. A loop 350 (earlier referenced as loop 196) of a hook 40 is displaced into loop 312 of snap ring 300C. Loop 310 of snap ring 300C is associated with weight 250 such that weight 250 and a portion of snap ring 300C is disposed in cavity 226 with at least loop 312 of snap ring 300C inferiorly exposed outside part 210′. Loop 310 of snap ring 300C may be affixed to weight 250 by carving a slot in weight 250 and adhesively affixing loop 310 therein or by molding loop 310 in place if weight 250 is formed by hot molding.

Part 210′ may be assembled by affixing loop 350 (earlier referenced in FIG. 3 as loop 194) of a hook 40 to loop 328 of omega clip 320C. Arm 322′ of omega clip 320C is then displaced into blind hole 346′. Weight 280 is displaced into cavity 260′.

To affix part 200′ to part 210′, arm 322′ of omega clip 320B is displaced into blind hole 344′ with loop 312 (earlier referenced as loop 140) of snap ring 300B threaded into loop 328 (earlier referenced as loop 190) of omega clip 320B. Such attachment hingeably affixes part 200′ to part 210′. Note that loop 312 of snap ring 300B is vertically oriented and loop 328 of omega clip 320B is horizontally oriented. So oriented, these loops promote wobble in fore part 20 and a wagging motion in rear part 30.

Following assembly of parts 200′ and 210′, part 200 is securely affixed to part 200′ and part 210 is similarly securely affixed to part 210′ to complete assembly of lure 10. These parts may be affixed mechanically, by adhesion, solvent bonding or by other processes such as ultrasonic welding. To use lure 10 for most fishing methods, only a line 90 need be affixed thereto. Lure 10 is inherently weighted for casting or trolling and is inherently stable when displaced through water, therefore not requiring connections using swivels.

The most surprising feature of lure 10 is its realistic swimming motion in water. Key to this action is a novel combination of weight 250 disposed in fore part 20, specially designed thinning of fore part 20 at thinned section 130, wedge 170 and, most importantly, weight 280 disposed in rear part 30. As may be seen by example in FIG. 12, due to action of this combination, lure 10 angularly departs from a direction of pull of line 90 (direction of pull is indicated by arrow 400).

As is well known in the art of fluid dynamics, stream (water or fluid) flow is steered by surface phenomena to flow inwardly across surfaces 152 and 152′ in direction of arrows 402 and 402′, respectively, when inward angulation of surfaces 152 and 152′ do not exceed critical angles. Such angles are well known and generally published in fluid dynamics texts, journals and handbooks.

Extending components 154 and 154′ act to further steer and thereby focus flow from surfaces 152 and 152′ in relatively parallel directions toward faces 160 and 160′ of wedge 170, an example of which is indicated by arrow 406. Note that, when rear part 30 is angularly displaced in a given direction, water flow acts to further displace rear part 30 in the same direction. It is important to note that, absent from other forces, rear part 30 would not wag.

However, force of water against opposing sides (numbered 410 and 410′) provide opposing forces which ultimately produce wagging. In this example, force of water against side 410′ ultimately overcomes wedge derived driving force, as depicted in the example of FIG. 12, and causes rear part 30 to be angularly displaced in the opposite direction producing bidirectional action as indicated by double ended arrow 420. While this wagging displacement is easily understood, it is important to note effect of weight 280 upon lure action as rear part 30 wags.

Due to mass and location of weight 280, rear part 30 tends to rotate (wag) about the center of mass of rear part 30 (which is substantially the center of mass of weight 280) in line with direction of pull 400, which may be seen extended through lure 10 along dashed line 422. Such rotation about that center of mass, distally removed from hinge 140, results in a lateral displacement of hinge loop 140 and resulting angular displacement of fore part 20. While action of lure 10 is widely varied, it may be seen that a small angular displacement of fore part 20 presents an asymmetric lure geometry to water moving toward lure 10 causing further lure displacement from direction of pull 400.

As has already been disclosed, action of for part 20 is a distinctive wobble, which results from the site of line 90 attachment site relative to weight 250 disposition. As water flows relative to inwardly disposed faces 150 and 150′ and as fore part 20 cants and wobbles, flow vectors are variously directed against faces 160 and 160′ which adds variety to the wagging mode of action of rear part 30.

In summary, wagging of rear part 30 is fed back through the hinged connection of link 140 (loop 312 of snap ring 300B) to link 190 (loop 328 of omega clip 320B). This creates a compound motion or action which appears to randomly thrust frontal section 50 from side to side while wobbling. The result is an action in which both rear part 30 (the tail) wags while the fore part 20 (the head) departs randomly from direction lure 10 is being pulled. This action continues through widely dispersed velocities of water displacement rate of lure 10 and begins immediately upon such displacement.

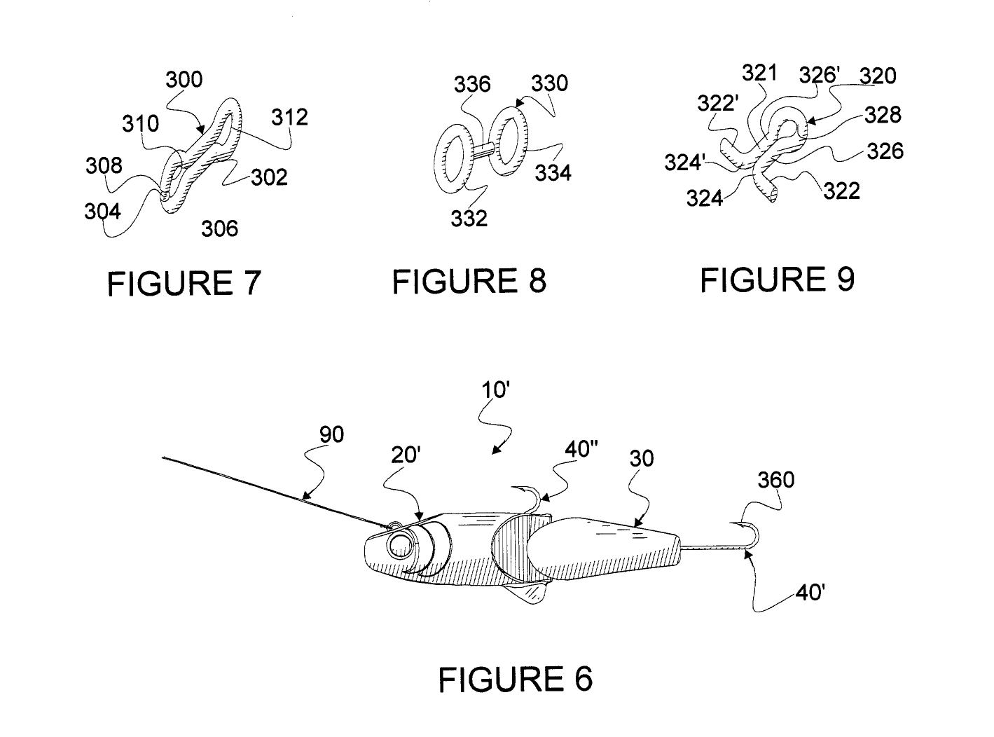

Such immediacy of action makes a lure fabricated according to the instant invention particularly appealing for jigging. A lure 10′ which is better suited for some jigging applications is seen in FIG. 6. Lure 10′ is similar in most form and function to lure 10 except for hook attachment and use. Note that an upright hook 40′ is affixed to rear part 30 of lure 10′. An upright hook 40′ has a vertically disposed barb 360 to minimize snagging while jigging. Also, a second upright hook 40″ is disposed as a substitute for dorsal fin 80. It has been experimentally determined that such a replacement of dorsal fin 80 by a hook such as hook 40″ results in a mode of action by lure 10′ which is substantially the same as the action of lure 10.

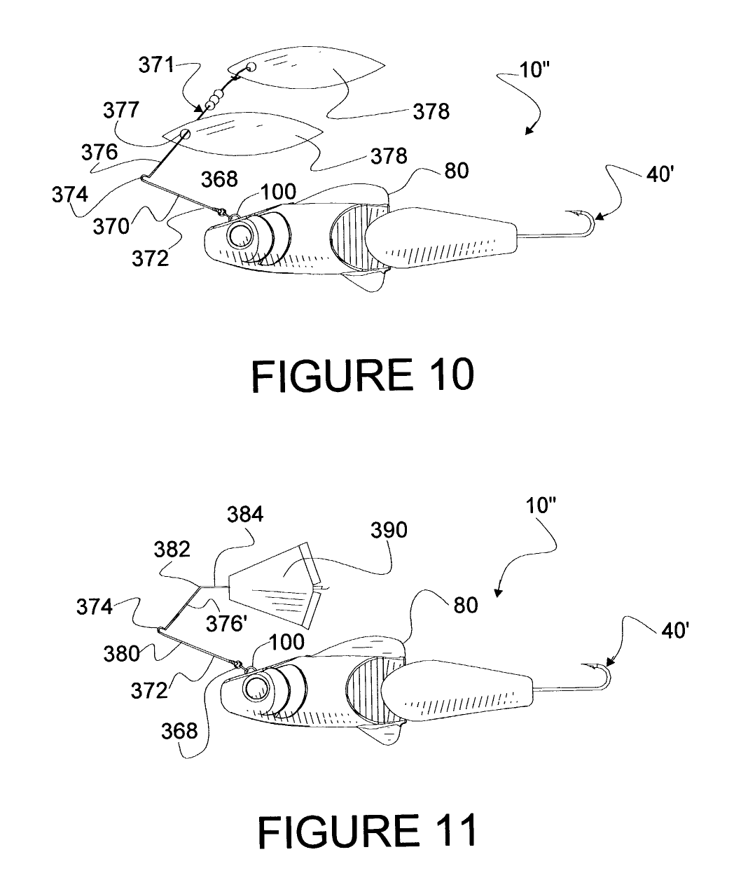

Reference is now made to FIGS. 10 and 11 where another embodiment of the invention in the form of lure 10″ is used variously as a spinner bait (FIG. 10) and as a buzz bait (FIG. 11). Lure 10″ is formed as a combination of parts of lures 10 and 10′. Lure 10″ comprises a rearwardly disposed upright hook 40′, similar to lure 10′ and a dorsal fin 80, similar to lure 10.

As seen in FIG. 10, lure 10″ is affixed, via loop 100 to a connector 368 of wire form 370. Note that inherent stability of lure 10″ permits nearly any kind of fishing lure connection to be made between wire form 370 and loop 100. Wire form 370 is a part of a spinner system 371. Spinner systems, of which spinner system 371 is an example, are well known and in wide use by fishermen. Wire form 370 has a well known shape, comprising an elongated substantially straight section 372 extending outward from connector 368 and arching in a nearly 1800 turn at a bend 374 to extend rearward via a second elongated section 376, to a connection point 377 where two spinner blades, generally numbered 378, are affixed. Usually a fishing line is affixed at bend 374 for trolling and jigging.

In FIG. 11, a wire form 380 is affixed through a connection 368 to lure 10″. Wire form 380 is similar in form to wire form 370, except at an end distal to lure 10″ an elongated section 376′ has a bend 382 before extending horizontally along a shorter section 384 to connect to a buzz blade 390. Wire forms, similar to wire form 380 and buzz blades are well known in fishing art.

In both configurations seen in FIGS. 10 and 11, lure 10″ is effective first because it is weighted and inherently stable, but second because vital swimming action of lure 10″ adds significantly to action of the combinations of lure 10″ and wire forms 370 and 380, with spinners 378 and buzz blade 390.

In all embodiments, the fore part, such as fore part 20 (e.g. parts 200 and 200′), and the rear part, such as rear part 30 (e.g. parts 210 and 210′), are preferably injection molded from synthetic resinous material which may be facilely joined by being mechanically affixed, adhesed, solvent bonded or by other processes, such as by ultrasound. As well a synthetic resinous material should be selected which can withstand the rigors of casting and trolling. There are many such materials which are commercially available including a variety of polycarbonates. Materials may be colored, translucent or transparent. As is well known in the lure making art, fish simulating patterns and colors may be painted on the lures to enhance simulation. Spray painting is preferred. Also weights, such as weight 250 and weight 280 may be colored to enhance attractiveness in translucent and transparent lures.

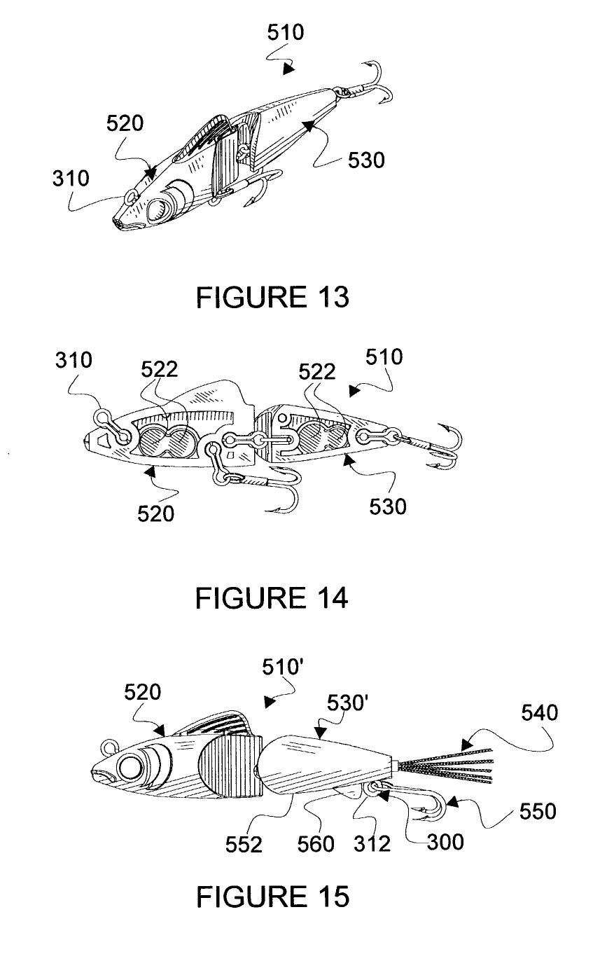

Reference is now made to FIGS. 13-17 wherein a variety of different embodiments of lures made according to the present invention are seen. As may be noted in FIGS. 13 and 14 a lure 510 is seen. Lure 510 is similar to lures 10, 10′ and 10″ except for additional facial and fin detail to a fore part 520 and a loop 310 being used for fishing line attachment instead of the combination of an omega clip 320 and a swiveling connector 330. As may be seen in FIG. 14, a plurality of spherical cavities, generally numbered 522, are disposed in fore part 520 and a rear part 520. Cavities 522 are sized and shaped to house spherical weights which are generally commercially available.

It is well known that flexible tails, which may be of a variety of colors, attract fish to lures. Such tails may be made from feathers, strands of material or other fabric which is generally preferably flexible. It is also well known that a preponderance of such material may be fragile and subject to rapid degradation when attacked by fish, and that one color may be effective at attracting fish at one time while another color may effective at another time. Also, parts of lures, except rear parts, may be far more costly to manufacture than rear parts.

For these reasons, it is highly desirable to provide a lure system which may be easily fitted with new rear parts. As seen in FIG. 15, a lure 510′, which is similar to lure 510, has a rear part 540 fitted to a rear part 530′. A two pronged hook 550 is inferiorly affixed to an underside 552 of part 530′ via a loop 312 of a snap ring 300. As it is possible for hook 550 to rotate and foul with rear part 540, a small fin 560 is ventrally disposed, adjacent to loop 312. So disposed, fin 560 retards rotation of hook 550, thereby eliminating fouling with rear part 540.

To permit facile replacement of one rear part 540 by another rear part 540, rear part 530′ has a latch 570 which may be dactylly offset to release a rear part 540 for removal from a rear part 530′ and released to snap into place and retain a replacement rear part 540 thereat. Latch 570 and other parts which may be used in lure 510′, and other lures which may be made utilizing the present invention, are seen in FIG. 17.

Similar to lure 10, lure 510′ may be manufactured in many ways within the scope of the invention. As seen in FIG. 17, fore part 520 may be molded as two separate parts, numbered 600 and 600′. Similarly rear part 530 may be molded as two separate parts, seen to be numbered 610 and 610′.

Note that only internal parts of one side (i.e. parts 600′ and 610′) are seen in FIG. 17. It should be noted that all features disclosed for parts 600′ and 610′ are repeated in substantially mirror image format in parts 600 and 610, except for complimentary features which are mentioned hereafter.

Part 600′ comprises a portion 80″ of dorsal fin 80 which is integrally molded as a part of part 600′. Inferiorly disposed relative to dorsal fin portion 80″, part 600′ comprises a plurality of cavities 620′ and 622′ which are spherical in shape. Likewise, part 610′ comprises a pair of spherically shaped cavities 624′ and 626′. These cavities were earlier generally referenced in FIG. 14 by the number 522. Further, part 600′ comprises raised edging, similar to part 200′, which acts as a tongue in a tongue and groove relationship with part 600 to permit parts 600′ and 600 to be joined and sealed to form a single part (i.e. fore part 520).

A spherical weight 650 is instructed by dashed line notation to be assembled in spherical cavity 620′. As is the case for weight 250 in lure 10, it is important that weight 650 (or at least the center of gravity of weight 650) be inferiorly disposed relative to a site where forces from an attached fishing line are imposed upon lure 510′. So disposed, weight 650 in combination with superiorly displaced connection of the fishing line and superior fore part features of which dorsal fin 80″ is an example, causes fore part 520 to wobble as it is displaced relative to a surrounding fluid (water) environment. The mass and density of weight 650 may be varied to adjust for predetermined fishing depth of lure 510′, rate of sinking when lure 510′ is jigged, ease of casting of lure 510′ and other variables which characterize lure 510′ for a desired fishing method. However, weight interrelationships noted for weight 250 (with 280) apply to weight 650. As an example, for a lure having a fore part 520, shaped as seen in FIGS. 13-16, having a maximum girth of 1.2 centimeters and a length of 3.75 centimeters, weight 650 may be approximately nine grams and should be disposed aft of loop 310 of snap ring 300D.

A loop for attaching fishing line (earlier numbered 90) is provided by installing a snap ring 300D into a slot 340″ as seen in FIG. 17. A subtle feature of fore part 520 is a sloped planar face 654 superiorly disposed relative to slot 340″. Planarity of face 654 markedly improves wobble action of fore part 520.

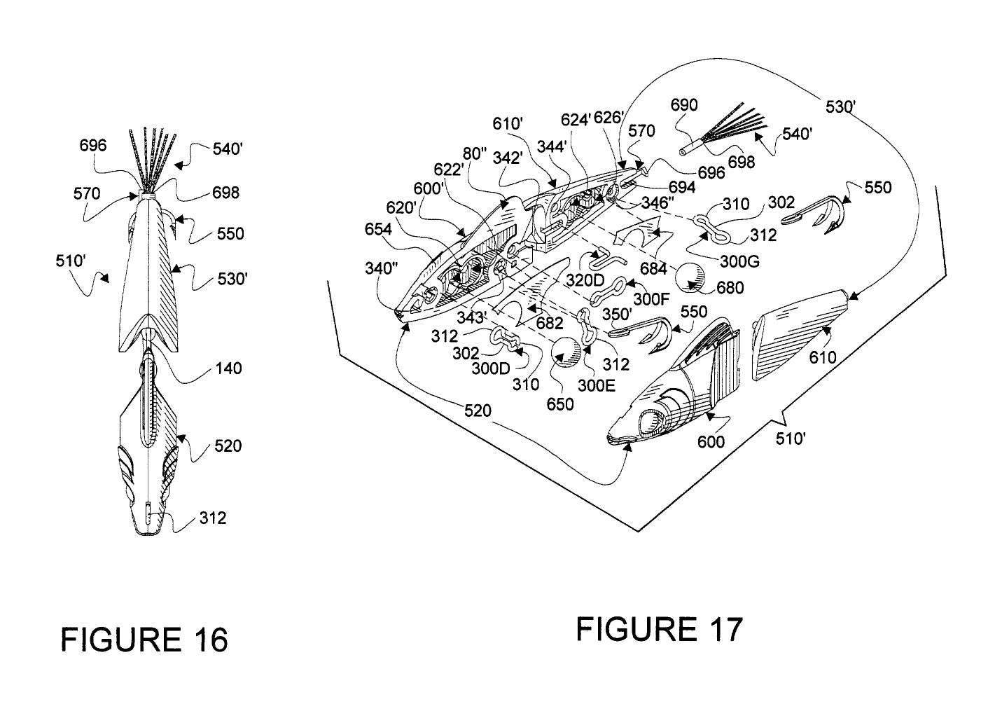

Part 610′, also comprises a plurality of open cavities which, like part 210′, are generally outlined by a raised edging which acts as a tongue in a tongue and groove relationship with part 610 to permit parts 610′ and 610 to joined and sealed to form a rear part (i.e. rear part 530′). In part 610′, cavities 624 and 626, when parts 610′ and 610 are joined, may each house a weight. At least one weight, i.e. weight 680 must be disposed into one of such cavities. As seen by dashed line direction, a weight 680 is assembled into cavity 624. Weight 680 should be disposed such that the center of gravity is along the line of force of pull of an associated fishing line. The center of gravity may be even higher if weight 650 is sufficiently heavy and so disposed to provide stability in light of disposition of weight 680. However, it is generally advisable to have the center of gravity of weight 680 disposed below the line of force of pull of the attached fishing line (see assembled placement of ring 300D). For a rear part 630 having a length of 3.75 centimeters, weight 680 may be approximately 1.8 grams, the center of gravity of which should reside about one centimeter behind hinge loop 140 (see FIG. 16).

As seen in FIG. 17, a plurality of loop connections are made to connect fore part 520, rear part 530′ and hooks 550 to provide an operable lure which is affixable to a fishing line. It should be duly noted that the loop connections are for the most part exemplary and other types of connections, especially hinge connections, may be made to assemble lure 510′ within the scope of the invention. The same connecting hardware disclosed for lure 10 may be used in various ways in lure 510′. See FIGS. 7-9.

It may be noted in FIG. 17 that connecting components used in lure 510′ are made up of a plurality of snap rings 300 and an omega clip 320. For clarity, in FIG. 17 each individual ring and clip is referenced by a number and a following character to specifically mark and identify each individual component. As an example, a connector associated with a fishing line attachment loop 312 (see FIG. 16) is numbered 300D (in FIG. 17). Please note that dashed lines provide an indication of direction of displacement for assembly of parts to construct lure 510′.

To affix connecting components to parts 600, 600′, 610 and 610′, each such part has a structure which comprises slots or holes in which the connecting components are securely anchored. As an example, part 600′ has a slot 340″ in which a loop 310 and arm 3302 of snap ring 300D is inserted. Rearward from hole 340″, part 600′ has a slot 342′ which is formed to anchor loop 310 of snap ring 300F.

Inferiorly disposed relative to hole 340″, part 610′ has a slot 343′ through which frame 302 of snap ring 300E is displaced such that loop 312 resides outside part 600′.

Part 610′ has a blind hole and slot 344′ for anchoring arm 322′ of omega clip 320D. Rearward from hole and slot 344′, part 610′ has a slot 346″ for loop 310 and arm 302 of snap ring 300G.

Though not shown, parts 600 and 610 have holes or slots which are complementary to those mentioned above for engaging and anchoring the referenced connecting components. Also for clarity, each hook 550 comprises a connecting loop 350′. An interesting aspect of two pronged hooks 550 is that shafts of the individual hooks are separate, parallel and a tightly associated by spring strength in the hooks. For this reason, hooks 550 may be assembled upon a connecting loop 350′ by simply threading one prong through a loop and pulling the hook fully onto an associated loop, e.g. loop 312 of snap ring 300G. Disassembly may be facilely achieved by an opposite action.

To assemble the part 600′, loop 328 of omega clip 320D is displaced into loop 312 of snap ring 300F. So assembled, loop 310 of snap ring 300F is displaced into slot 342′ of part 600′. Note that each hook 550 may be affixed after lure 510′ is otherwise completely assembled. In any event one hook 550 may be affixed to loop 312 of snap ring 300D and the other hook 550 may be affixed to loop 312 of snap ring 300G.

Weight 680 is displaced into cavity 624′. To affix part 600′ to part 610′, arm 322′ of omega clip 320D is displaced into the blind hole of hole and slot 344′ with loop 312 of snap ring 300F threaded into loop 328 of omega clip 320D. Such attachment hingeably affixes part 600′ to part 610′ (i.e. forms hinge loop 140 and loop 190, respectively). Note that loop 312 of snap ring 300F is vertically oriented and loop 328 of omega clip 320D is horizontally oriented. So oriented, these loops promote wobble in fore part 520 and a wagging motion in rear part 530′.

To add internal color to lure 510′, and any other lure made according to the present invention holographic inserts may be used, such as inserts 682 and 684, seen in FIG. 17. Note that inserts 682 and 684, as seen, cover cavities 622 and 626, respectively. In this case, lure 510′ only utilizes weights disposed in cavities 620 and 624. Should is be desired to utilize either of the covered cavities, inserts 682 and 684 should be differently formed to provide access to the desired cavities.

A replaceable tail 540′ is seen in FIG. 17 to comprise a hollow cylindrical receptacle 690 into which a plurality of strands 692 are securely affixed. To provide a releaseable housing for tail 540′, side 610′ has latch 570 which is disposed about a cylindrically shaped slot (formed when part 610′ is joined with part 610 to form part 530′). That portion of the cylindrically shaped slot, which is in part 610′, is numbered 694. As seen in FIG. 16, latch 570 has an inwardly disposed lip 696 which catches upon a distal end 698 of receptacle 690 when receptacle 690 is inserted into the cylindrical orifice partially formed by slot 694. Tail 540′ is facilely removed by dislacing latch 570 and displacing tail 540 rearwardly, permitting a replacement tail 540′ to be inserted and latched into place.

Following assembly of parts 600′ and 610′, part 600 is securely affixed to part 600′ and part 610 is similarly securely affixed to part 610′ to complete assembly of lure 510′. These parts may be affixed mechanically, by adhesion, solvent bonding or by other processes such as ultrasonically. To use lure 510′ for most fishing methods, only a fishing line need be affixed thereto. Like lur 10, lure 510′ is self-weighted for casting or trolling and is inherently stable when displaced through water, therefore not requiring connections using swivels.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed and desired to be secured by Letters Patent is:

1. A hard bait fishing lure comprising:
a fore part which is essentially symmetrical about a first vertical plane and which comprises a bulbous forward portion, wherein a loop for attaching a fishing line is securely affixed above and forward from a center of gravity of the fore part, an aft portion which is disposed rearward from the center of gravity and which is thinned and contoured to steer water flowing across the bulbous portion first toward and then substantially parallel to the first vertical plane and a weight disposed beneath the loop and between the loop and the thinned portion to fix the site of the center of gravity and of rotation of the fore part in free space;
an elongated rear part, which is essentially symmetrical about a second vertical plane, comprising a pair of vertically disposed, forward facing fascia, each of which forms a forwardly disposed acute angle with the second vertical plane, and a weight disposed to fix the center of gravity and of rotation of the rear part in free space at a predetermined site rearward from said fascia; and
a hinge which interconnects the fore and rear parts, forming a junction of the two vertical planes, and which facilitates wagging of the rear part such that water steered by the thinned portion acts upon the fascia to cause the rear part to rotate about the center of rotation of the rear part with an angular momentum that thrusts the hinge outward from the direction of tow of the fishing line and causing the bulbous portion and loop to angularly depart from the direction of tow of the fishing line.

2. The hard bait fishing lure according to claim 1 wherein the connecting hinge is an eyelet hinge.

3. The hard bait fishing lure according to claim 2 wherein said eyelet hinge comprises a foreward part which is vertically disposed.

4. The hard bait fishing lure according to claim 1 wherein the fore part comprises a loop whereat a fish hook is affixed.

5. The hard bait fishing lure according to claim 1 wherein the rear part comprises a loop and a fish hook thereat affixed.

6. The hard bait fishing lure according to claim 5 wherein said fish hook is a two pronged hook.

7. The hard bait fishing lure according to claim 6 wherein said loop is disposed at a ventral aft site of said rear part which further comprises a aft-end tail, superiorly disposed thereto, and ventral fin adjacent the loop for the purpose of eliminating fouling of the two pronged fish hook with the tail.

8. The hard bait fishing lure according to claim 1 where in the fore part comprises an elongated fore body part having a medially disposed first long axis, a fore part vertical dimension which comprises a superiorly disposed fore body part region relative to the first long axis and an inferiorly disposed fore part region relative to the first long axis and a fore body part horizontal dimension which defines fore body part body width about the first long axis.

9. The hard bait fishing lure according to claim 8 wherein the rear part comprises a second medially disposed long axis a tail body part vertical dimension which comprises a superiorly disposed rear body part region relative to the second long axis and an inferiorly disposed tail body part region relative to the second long axis and a tail body part horizontal dimension which defines rear part body width about the second long axis.

10. The hard bait fishing lure according to claim 9 wherein said fore part body comprises a dorsal fin stabilizing structure superiorly disposed relative to said first long axis and the weight of said fore part has a center of gravity which is inferiorly disposed relative to said first long axis, and the loop for communicating with a fishing line being superiorly disposed relative to said first center of gravity and inferiorly disposed relative to said dorsal fin such that pendulous action between forces acting upon the dorsal fin and first weight about the loop communicating with the fishing line causes the fore part to wobble.

11. The hard bait fishing lure according to claim 10 wherein the weight of said rear part has a center of gravity which is inferiorly disposed relative to said second long axis, and the pair forward facing fascia.

12. The hard bait fishing lure according to claim 1 wherein the fishing line attaching loop is an articulating loop hingeably affixed to the fore part to provide facile access to the loop while a fishing line is affixed thereto and rotated to a site hidden from a side view of the fore part when the lure is towed through water.

13. The hard bait fishing lure according to claim 1 wherein the fore part comprises a planar area about the fishing line communicating loop, said area being rearwardly sloped upward.

14. The hard bait fishing lure according to claim 13 wherein the planar area comprises an angular upward slope of approximately 20°.

15. The hard bait fishing lure according to claim 1 wherein said lure comprises a spinner bait wire form is interposed between the loop and the fishing line.

16. The hard bait fishing lure according to claim 1 wherein said lure comprises a buzz bait wire form is interposed between the loop and the fishing line.

17. The hard bait fishing lure according to claim 1 wherein said rear part comprises a holder and a releasible latch for a replaceable tail.

18. The hard bait fishing lure according to claim 17 further comprising at least one replaceable tail having a fitting which communicates with said holder to releasibly latch the replaceable tail to the rear part.

19. A method for actuating a fishing lure to simulate swimming, said method comprising the steps of:
providing a hard bait fishing lure comprising:
a fore part which is essentially symmetrical about a first vertical plane and which comprises a bulbous forward portion, wherein a loop for attaching a fishing line is securely affixed above and forward from a center of gravity of the fore part, an aft portion which is disposed rearward from the center of gravity and is thinned and contoured to steer water flowing across the bulbous portion first toward and then substantially parallel to the first vertical plane and a weight disposed beneath the loop and between the loop and the thinned portion to fix the site of the center of gravity and of rotation of the fore part in free space;
an elongated rear part, which is essentially symmetrical about a second vertical plane, comprising a pair of vertically disposed, forward facing fascia, each of which forms a forwardly disposed acute angle with the second vertical plane, and a weight disposed to fix the center of gravity and of rotation of the rear part in free space at a predetermined site rearward from said fascia;
a hinge which interconnects the fore and rear parts, forming a junction of the two vertical planes, and facilitates wagging of the rear part; and
via the fishing line displacing the lure through water in a predetermined direction such that water which flows across the bulbous portion and is steered by the thinned portion to act upon the fascia causing rotation substantially about the center of rotation of the rear part such that resulting angular momentum of the rear part thrusts the hinge outward from the direction of fishing line displacement of the lure thereby inducing rotation about the center of rotation of the fore part which causes the bulbous portion and loop to angularly depart from the direction of tow of the fishing line.

20. A hard bait lure system comprising:
a lure having a head portion and a tail portion which comprises a an aft disposed housing with a releasible latch for a replaceable tail fitting;
a replaceable tail comprising a fitting which is releasibly displaced into said housing and latched therein.
